(19) United States
(12) Patent Application Publication
(10) Pub. No.: US 2009/0204773 A1
(43) Pub. Date: Aug. 13, 2009

(54) METHOD OF WRITING DEVICE DATA IN DUAL CONTROLLER NETWORK STORAGE ENVIRONMENT

(75) Inventors: Xu-Ming ZHANG, Tianjin (CN); Tom CHEN, Taipei (TW); Win-Harn LIU, Taipei (TW)

Correspondence Address: Workman Nydegger;1000 Eagle Gate Tower, 60 East South Temple, Salt Lake City, UT, 84111, US

(73) Assignee: INVENTEC CORPORATION, Taipei (TW)

(21) Appl. No.: 12/027,861

(22) Filed: Feb. 7, 2008

(51) Int. Cl. G06F 13/00; G06F 12/00

(52) U.S. Cl. 711/162; 711/112; 711/E12.001; 711/E12.002

(57) ABSTRACT

A method of writing device data in a dual controller network storage environment is described. According to the method, functions of a virtual data router (VD router) and a mirror technology are integrated, so as to efficiently transmit internal network data and write data into disk devices on different controllers in a dual controller network storage environment. Thereby, the internal network data transmission efficiency and actual internal network utilization can be improved.

### BACKGROUND OF THE INVENTION

1. Field of Invention

The present invention relates to a method of writing device data in a dual controller network storage environment, and more particularly to a method of writing device data in a dual controller network storage environment that integrates functions of a VD router and a mirror technology.

2. Related Art

Currently, multi-path input output (MPIO) technology is widely utilized in a dual controller environment, for performing data storage and read/write operations on a network storage device. Through the MPIO technology, a network storage device is accessed via one or more physical links, and network storage applications become more adaptable with better performances by means of I/O scheduling strategies of fault tolerant, traffic load balance, and fine granularity. The MPIO technology requires to make mapping backups of disk access paths, and to access a disk via any path. As such, when a path goes abnormal, another path may be used to access the storage device, thus preventing the services and connections from interruption.

Presently, in the conventional art, a VD router is an indispensable part in the path backup technology for realizing MPIO. Thus, a virtual disk device on a controller may be simultaneously accessed from different storage controllers by a method of realizing MPIO in a dual controller network storage environment provided by the VD router.

The mirror technology in the conventional art provides a method of protecting data mirror in a dual controller network storage environment. According to the method, when data is written into a local device, a complete data mirror is saved in another controller (the data mirror is stored in an internal memory). Therefore, when the local controller goes abnormal, the partially damaged data due to the abnormal event may be recovered by the backup mirror data in another controller, thus ensuring the data completeness after a single controller goes abnormal in a dual controller environment.

The functions of the VD router and mirror technology are both realized through internal network data transmission in a dual controller environment. That is, data should be transmitted from one controller to the other via the internal network, data packets to be transmitted have to contain some information relative to the device, and a result feedback mechanism is needed to ensure the correctness of data transmission.

However, in the conventional art, the mirror technology captures data after a device write call, i.e., data is captured below a device read/write interface, and the function of the VD router is realized before the device write call, i.e., data is transmitted above the device read/write interface when the VD router is writing in a local or remote device. As parameters transmitted during the write of a device are simple, the mirror technology may not be able to identify whether data is written locally or by a VD router, and all the written data will be sent to an end (i.e., another controller) for saving mirror data through the mirror function. If the data is a write request sent by the VD router, the data is sent from the remote controller to the local on the VD router layer. After finishing the data read/write operation, the local device will again feed back the data to the remote controller by the mirror function, and thus one more internal network data transmission in a completely opposite direction occurs. As a result, the actual internal network utilization is only 50%, and the other 50% is just a waste of time, so the internal network data transmission efficiency is greatly weakened.

### SUMMARY OF THE INVENTION

To solve the problems and defects in the conventional art, the present invention is directed to a method of writing device data in a dual controller network storage environment. According to the method, functions of a VD router and a mirror technology are integrated, so as to efficiently transmit internal network data and write data into disk devices on different controllers in a dual controller network storage environment including a local controller and a remote controller.

A method of writing device data in a dual controller network storage environment includes the following steps.

First, a disk data write request is monitored and received in real time. On receiving the disk data write request, it is determined whether a disk device to be accessed by the data write request is located on the local controller or the remote controller. If the disk device to be accessed is located on the local controller, the data to be written is packaged into a mirror request according to a format required by mirror data and the mirror request is then sent to the remote controller. Afterward, the data to be written is written into the disk device on the local controller, an operation result is fed back after the data write operation is finished, and the remote controller writes the received data into a cache thereof. On the contrary, if the disk device to be accessed is located on the remote controller, the data to be written is first written into a cache of the local controller. Then, the data is packaged into a VD router request and sent to the remote controller, so as to perform a data write operation on the disk device, and an operation result is fed back after the data write operation is finished.

In view of the above, the present invention has the following advantages.

A method of writing device data in a dual controller network storage environment is provided, in which functions of a VD router and a mirror technology are reasonably integrated, so as to efficiently transmit internal network data and write data into disk devices on different controllers in a dual controller network storage environment. The method of the present invention is superior to the conventional art in the following aspects. First, the method of the present invention handles the mirror and VD router requests together, so as to prevent internal network data from being transmitted twice in a dual controller network storage environment in the conventional art, thereby effectively reducing the occupancy of network resources, and improving the internal network data transmission efficiency and actual internal network utilization. Secondly, the method of the present invention adopts the same program interface for performing data packaging and resolution, thereby avoiding repeated coding and improving the utilization of program codes. Thirdly, the method of the present invention integrates the mirror backup and VD router-server process in the conventional art into a VM Daemon process, so as to omit a switching in the data write process, thus improving the execution speed of the program codes.

### BRIEF DESCRIPTION OF THE DRAWINGS

The present invention will become more fully understood from the detailed description given herein below for illustration only, and thus are not limitative of the present invention, and wherein:

FIG. 1 is a flow chart of a method of writing device data in a dual controller network storage environment according to the present invention.

### DETAILED DESCRIPTION OF THE INVENTION

Preferred embodiments of the present invention will be illustrated in detail below with the accompanying drawings.

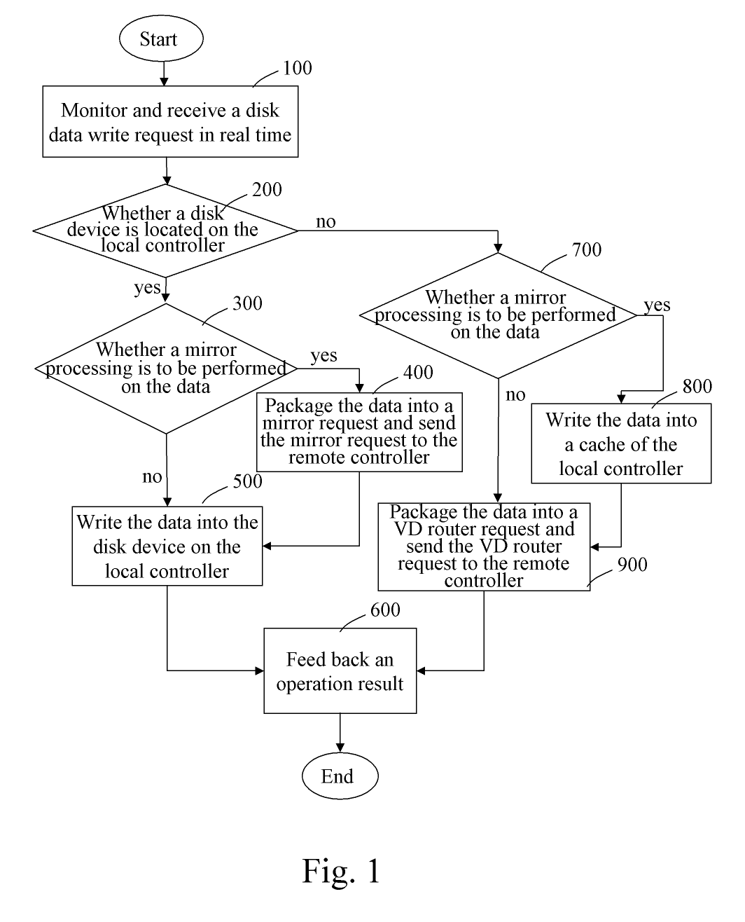

Referring to FIG. 1, a flow chart of a method of writing device data in a dual controller network storage environment according to the present invention is shown. According to the method of the present invention, functions of a VD router and a mirror technology are integrated, so as to efficiently transmit internal network data and write data into disk devices on different controllers in a dual controller network storage environment including a local controller and a remote controller. The method includes the following steps.

First, a disk data write request is monitored and received in real time (Step 100).

On receiving the disk data write request, it is determined whether a disk device to be accessed by the data write request is located on the local controller or the remote controller (Step 200).

If the disk device to be accessed is located on the local controller, it is further determined whether a mirror processing is to be performed on the data to be written (Step 300). If a mirror processing needs to be performed on the data, the data to be written is packaged into a mirror request according to a format required by mirror data and the mirror request is then sent to the remote controller (Step 400). Afterward, the data to be written is written into the disk device on the local controller (Step 500), and an operation result is fed back after the data write operation is finished (Step 600). In addition, the remote controller writes the received data into a cache thereof (not shown) after receiving the mirror request. On the contrary, if a mirror processing does not need to be performed on the data, the data to be written is written into the disk device on the local controller (Step 500), and an operation result is fed back after the data write operation is finished (Step 600).

If the disk device to be accessed is located on the remote controller, it is further determined whether a mirror processing is to be performed on the data to be written (Step 700). If a mirror processing needs to be performed on the data, the data to be written is first written into a cache of the local controller (Step 800). Then, the data is packaged into a VD router request and sent to the remote controller (Step 900), so as to perform a data write operation on the disk device of the remote controller and feed back an operation result after the data write operation is finished (Step 600). On the contrary, if a mirror processing does not need to be performed on the data, the data to be written is packaged into a VD router request and sent to the remote controller (Step 900), so as to perform a data write operation on the disk device of the remote controller and feed back an operation result after the data write operation is finished (Step 600). Till now, the data processing in the method of writing device data in a dual controller network storage environment provided by the present invention ends successfully. Seen from the whole process of the method, no matter the disk device to be accessed by the data write request is located on the local controller or the remote controller, the strategy of integrating the VD router with the mirror technology can fulfill the disk data write request from a subscriber by transmitting internal network data only once.

Moreover, in the method of writing device data in a dual controller network storage environment provided by the present invention, the process of writing data into the cache of the local controller or the remote controller further includes the following steps.

Information about the handle, data write position, and write length of the cache is obtained; then the data is packaged into a data format and data structure required by the cache; and a data write interface of the cache is called to finish writing data into the cache.

In addition, in the method of writing device data in a dual controller network storage environment provided by the present invention, the process of writing data into the disk device of the local controller or the remote controller further includes the following steps.

Information about the handle, data write position, and write length of the disk device is obtained, and an I/O interface of the disk device is called to finish writing data into the disk device.

Further, in the method of writing device data in a dual controller network storage environment provided by the present invention, the mirror request and the VD router request are in the same format, and identified by different flags, such that corresponding operations may be employed without requiring additional data storage capacity.

Finally, it should be noted that, the method of the present invention integrates the mirror backup with VD router-server process in the conventional art. Thus, a VM Daemon process is realized on each controller in a dual controller network storage environment. The VM Daemon keeps on monitoring the socket of each controller to see if a request is newly sent by another controller, and then determines whether data is written into a disk device or a cache according to the request type information contained in the received request. If the data is to be written into a disk device (i.e., the received request is a VD router request), information about the handle, data write position, and write length of the disk device is obtained, then an I/O interface of the disk device is called to finish writing data into the disk device, and an operation result is fed back to the request sender. On the contrary, if the data is to be written into a cache (i.e., the received request is a mirror request), information about the handle, data write position, and write length of the cache is obtained, then the data is packaged into a data format and a data structure required by the cache, afterward a data write interface of the cache is called to finish writing data into the cache, and an operation result is fed back to the request sender. If the request newly received by the VM Daemon process is neither a VD router request nor a mirror request, an error processing is performed, and an operation result is fed back to the request sender.

During the data write process, on receiving a disk data write request from an upper layer, the VM Daemon process first determines whether the disk device is located on the local controller. If the disk device is located on the local controller, an I/O interface of the disk device is called to write data into the disk device of the local controller. Then, the data is packaged into a mirror request and sent to the VM Daemon process on another controller to be processed therein. If the disk device is located on another controller instead of the local one, the data is first packaged into a format required by the cache and then written into the cache. After that, the data is further packaged into a VD router request and sent to the VM Daemon process on another controller to be processed therein.

What is claimed is:

1. A method of writing device data in a dual controller network storage environment, wherein functions of a virtual data router (VD router) and a mirror technology are integrated, so as to efficiently transmit internal network data and write data into disk devices on different controllers in a dual controller network storage environment comprising a local controller and a remote controller, the method comprising:
monitoring and receiving a disk data write request in real time;
on receiving the disk data write request, determining whether a disk device to be accessed by the data write request is located on the local controller or the remote controller;
if the disk device is located on the local controller, packaging the data to be written into a mirror request according to a format required by mirror data and sending the mirror request to the remote controller, then writing the data to be written into the disk device on the local controller, and feeding back an operation result after the data write operation is finished; and
if the disk device is located on the remote controller, first writing the data to be written into a cache of the local controller, then packaging the data to be written into a VD router request, sending the VD router request to the remote controller, so as to perform a data write operation on the disk device and feed back an operation result after the data write operation is finished.

2. The method of writing device data in a dual controller network storage environment as claimed in claim 1, after packaging the data to be written into a mirror request according to a format required by mirror data and sending the mirror request to the remote controller, further comprising the remote controller writing the received data into a cache thereof.

3. The method of writing device data in a dual controller network storage environment as claimed in claim 1, wherein the process of writing data into the cache of the local controller or the remote controller further comprises:
obtaining information about the handle, data write position, and write length of the cache;
packaging the data into a data format and a data structure required by the cache; and
calling a data write interface of the cache to finish writing data into the cache.

4. The method of writing device data in a dual controller network storage environment as claimed in claim 2, wherein the process of writing data into the cache of the local controller or the remote controller further comprises:
obtaining information about the handle, data write position, and write length of the cache;
packaging the data into a data format and a data structure required by the cache; and
calling a data write interface of the cache to finish writing data into the cache.

5. The method of writing device data in a dual controller network storage environment as claimed in claim 1, wherein the process of writing data into the disk device of the local controller or the remote controller further comprises:
obtaining information about the handle, data write position, and write length of the disk device; and
calling an I/O interface of the disk device to finish writing data into the disk device.

6. The method of writing device data in a dual controller network storage environment as claimed in claim 1, wherein the mirror request and the VD router request are in the same format, and identified by different flags.
